(19) United States
(12) Patent Application Publication
(10) Pub. No.: US 2002/0188476 A1
(43) Pub. Date: Dec. 12, 2002

(54) Process and computer system for providing prescription history information to an insurer

(76) Inventors: Thomas H. Bienvenu II, Stillwell, KS (US); Gregg R. Sadler, Overland Park, KS (US)

Correspondence Address: William B. Kircher, SHOOK, HARDY, & BACON L.L.P., 1200 Main Street, Kansas City, MO, 64105-2118, US

(21) Appl. No.: 09/879,701

(22) Filed: Jun. 12, 2001

(51) Int. Cl. G06F 17/60

(52) U.S. Cl. 705/3

(57) ABSTRACT

A computer system for providing prescription drug history information to an insurer is provided. The method includes receiving a history request message and transmitting a number of individual history requests over a communication network to a number of remote computers of pharmacy benefit managers. The method also includes receiving at least one prescription history response generated by accessing a database of prescription history information at one of the remote computers.

### CROSS-REFERENCE TO RELATED APPLICATIONS

“Not Applicable”

### STATEMENT REGARDING FEDERALLY SPONSORED RESEARCH AND DEVELOPMENT

“Not Applicable”

### TECHNICAL FIELD

The present invention relates to a process and a computer system, more particularly, to a process and computer system for providing prescription history information to an insurer.

### BACKGROUND OF THE INVENTION

In the past, insurers have used a variety of methods to determine the risks associated with insuring a particular individual, processing claims, and other insurance processes. For example, when an applicant [symbol] s age, amount of coverage desired, or any of a number of other factors require close scrutiny of the risks of issuing a policy, the insurer may order an Attending Physician Statement (APS). The APS is used to learn about unknown medical conditions, clarify the conditions listed on the individual's application and to obtain a limited, and oftentimes incomplete, prescription history for the applicant. While APSs are useful tools, significant delays and costs are incurred to obtain, study and analyze the statements, and incorporate the information into the insurer[]s decision making process.

Similarly, certain insurance claims warrant close scrutiny, and in such cases, a prescription history may be ordered. In the past obtaining a prescription history for claims processing has been a labor intensive and expensive task with little prospect that complete information would be obtained. Armed with an authorization, an independent contractor surveys a number of pharmacies within the locality where the insured resided. In addition to the possibility that the appropriate pharmacies are left unchecked, this method of obtaining prescription history information is fraught with human errors, delays, expense and other serious drawbacks.

In recent years, prescription drug information has been stored within the databases of large Pharmacy Benefit Managers (PBMs). PBMs are third party administrators that process prescription drug programs for insurers. At this time, it has been estimated that the largest five PBMs have about 210 million members. However, in the past, this information has not been used in the insurance process, and the traditional APSs or pharmacy surveys have been required to learn about the prescription history of the applicant or insured.

Accordingly, there is a need for an effective system and method for accessing prescription drug history information stored in the databases of PBMs, processing the information, and incorporating the information in the insurance process.

### BRIEF SUMMARY OF THE INVENTION

Generally described, a computer system for providing prescription drug history information to an insurer is provided. The method includes receiving a history request message, and transmitting a number of individual history requests over a communication network to a number of remote computers of pharmacy benefit managers. The method also includes receiving at least one prescription history response generated by accessing a database of prescription history information at one of the remote computers, and transmitting prescription history information to the insurer.

In another aspect of the invention, a method for screening the prescription history of an individual is provided. The method includes the steps of receiving a history request from an insurer and sending a number of individual requests for prescription history information to a number of pharmacy benefit managers. The method also includes receiving prescription history information responses from at least one of the pharmacy benefit managers and transmitting the prescription history information of the individual to the insurer.

Additional aspects, advantages and novel features of the invention will be set forth in part in a description which follows, and in part will become apparent to those skilled in the art upon examination of the following, or may be learned by practice of the invention.

### BRIEF DESCRIPTION OF THE SEVERAL VIEWS OF THE DRAWING

The present invention is described in detail below with reference to the attached drawing figures, wherein:

FIG. 1 is a schematic diagram of a suitable computing system environment for use in implementing the present invention;

FIG. 2 is a flowchart illustrating a preferred method for processing prescription history information and incorporating the information into the insurance process;

FIG. 3 illustrates an exemplary history request window;

FIG. 4 illustrates a flowchart showing the aggregation of individual response messages obtained from the remote computers at the PBMs, and

FIG. 5 illustrates a prescription report containing the information of the aggregated message sent from the system of the present invention to the insurer.

### DETAILED DESCRIPTION OF THE INVENTION

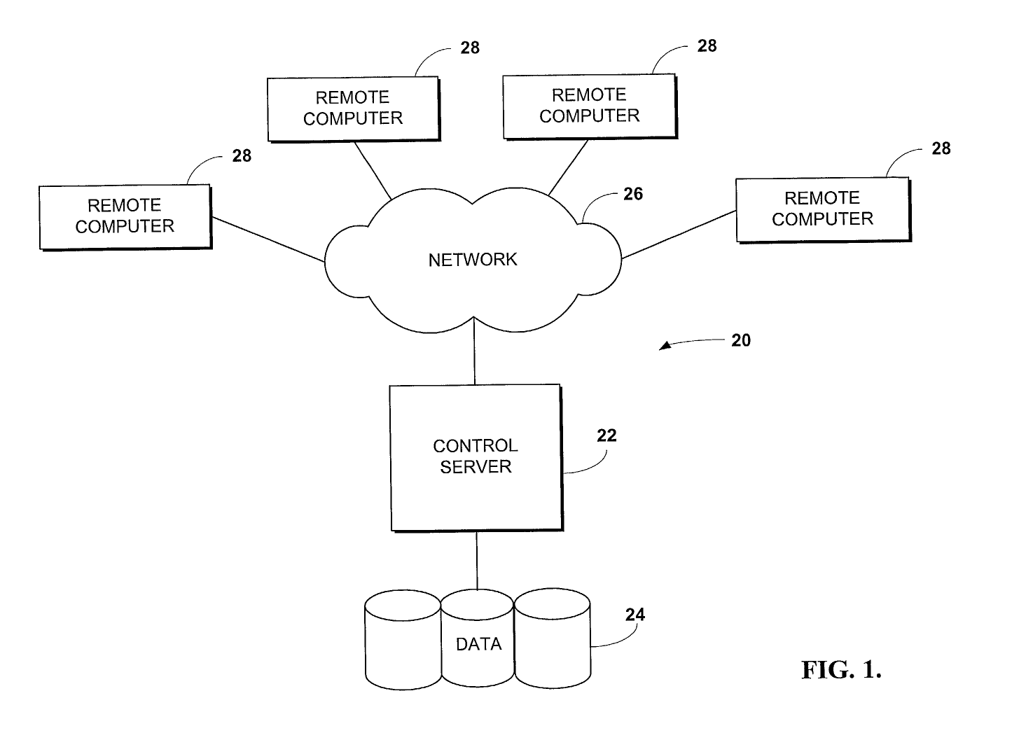

The present invention provides a method and system for screening the prescription history of an insurance applicant or insured. FIG. 1 illustrates a suitable computing system environment 20 on which the invention may be implemented. The computing system environment 20 is only one example of a suitable computing environment and is not intended to suggest any limitation as to the scope of use or functionality of the invention. Neither should the computing environment 20 be interpreted as having any dependency or requirement relating to any one or combination of components illustrated in the exemplary environment 20.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media, including memory storage devices.

With reference to FIG. 1, an exemplary computer system for implementing the invention includes a general purpose computing device in the form of server 22. Components of server 22 may include, but are not limited to, a processing unit, internal system memory, and a suitable system bus for coupling various system components, including database cluster 24 to the control server 22. The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Server 22 typically includes therein or has access to a variety of computer readable media, for instance, database cluster 24. Computer readable media can be any available media that can be accessed by server 22, and includes both volatile and nonvolatile media, removable and nonremovable media. By way of example, and not limitation, computer readable media may comprise computer storage media and communication media. Computer storage media includes both volatile and nonvolatile, removable and nonremovable media implemented in any method or technology for storage of information, such as computer readable instructions, data structures, program modules or other data. Computer storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 22. Communication media typically embodies computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared and other wireless media. Combinations of any of the above should also be included within the scope of computer readable media.

The computer storage media, including database cluster 24, discussed above and illustrated in FIG. 1, provide a storage of computer readable instructions, data structures, program modules, and other data for server 22.

Server 22 may operate in a computer network 26 using logical connections to one or more remote computers or client machines 28. Remote computers 28 can be located at a variety of locations, and are preferably located at sites associated with the insurer and PBMs such as principal and satellite offices and off-site computers associated with the insurer or PBMs. However, the remote computers may be located at sites associated with the applicant or insured, or other sites not typically associated with the insurance environment. Remote computers 28 may be a personal computer, server, router, a network PC, a peer device or other common network node, and may include some or all of the elements described above relative to server 22. Computer network 26 may be a local area network (LAN) and/or a wide area network (WAN), but may also include other networks. Such networking environments are commonplace in offices, enterprise-wide computer networks, intranets and the Internet. When utilized in a WAN networking environment, server 22 may include a modem or other means for establishing communications over the WAN, such as the Internet. In a networked environment, program modules or portions thereof may be stored in server 22, or database cluster 24, or on any of the remote computers 28. For example, and not limitation, various application programs may reside on the memory associated with any one or all of remote computers 28. It will be appreciated that the network connections shown are exemplary and other means of establishing a communications link between the computers may be used.

A user may enter commands and information into server 22 or convey the commands and information to the server 22 via remote computers 28 through input devices, such as keyboards, pointing devices, commonly referred to as a mouse, trackball, or touch pad. Other input devices may include a microphone, joy stick, game pad, satellite dish, scanner, or the like. Server 22 and/or remote computers 28 may have any sort of display device, for instance, a monitor. In addition to a monitor, server 22 and/or computers 28 may also include other peripheral output devices, such as speakers and printers.

Although many other internal components of server 22 and computers 28 are not shown, those of ordinary skill in the art will appreciate that such components and their interconnection are well known. Accordingly, additional details concerning the internal construction of server 22 and computer 28 need not be disclosed in connection with the present invention.

The method and system of the present invention receives history request messages from an insurer, transmits requests to remote computers at PBMs and receives prescription history responses from the PBMs. Although the method and system are described as being implemented in a WINDOWS operating system operating in conjunction with an Internet based system, one skilled in the art would recognize that the method and system can be implemented in any system supporting the processing of prescription drug information from PBM databases.

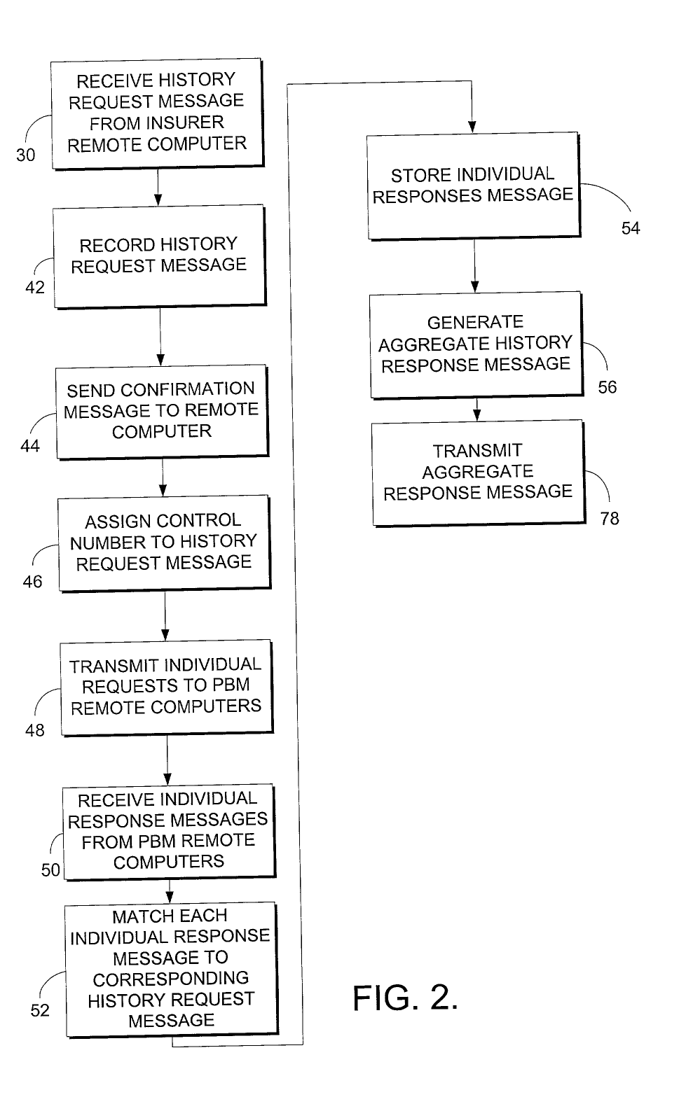

The operation of the system and method will be described with reference to the flowchart in FIG. 2. In the first step of the system, a history request message is received at step 30. Preferably, the history request message is generated at a remote computer 28 under the operation of the insurer. The message is sent from the remote computer 28 over the network and is received by server 22.

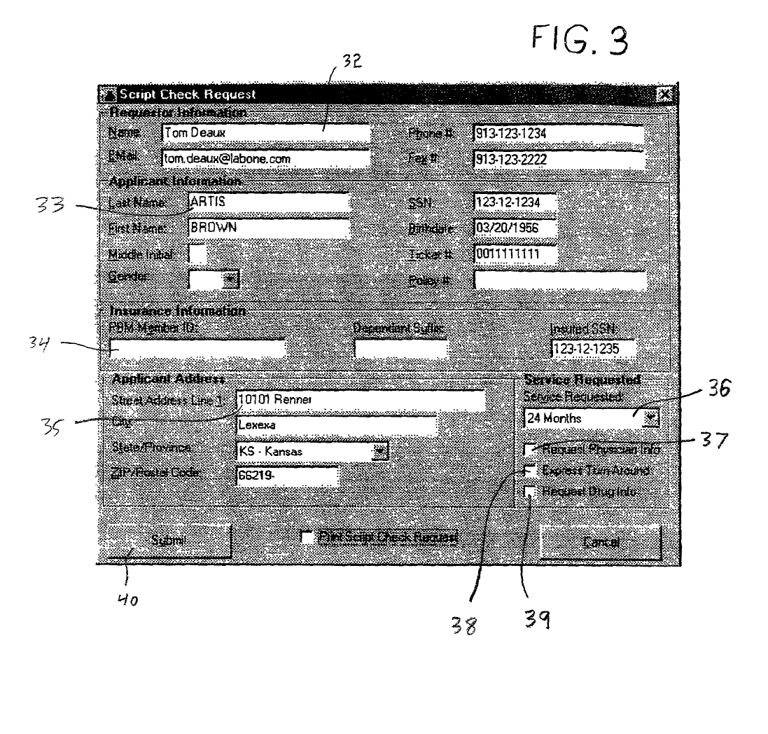

As shown in FIG. 3, an exemplary user interface WINDOW for requesting information is shown. After receiving the consent of the applicant or insured to access the prescription information, the insurer inputs history request information at a remote computer 28 that is transmitted as part of the history request message at step 30. Specifically, in the first set of fields 32, the insurer inputs the user's name, email address, phone number and/or facsimile number. In fields 33, the insurer inputs the name, gender, date of birth, and social security number of the applicant or insured. Information relative to the insurance policy for which the applicant has applied, the claim being investigated, or other insurance purpose for which the prescription history is being requested may also be input in the fields 33. Additional insurance information such as the PBM member number of the applicant or insured, the dependent suffix and social security number may also be input in fields 34 to assist in searching the PBM databases.

Preferably, the history request messages may also include information indicative of the quantity, quality or type of information desired by the insurer. Again, with reference to FIG. 3, as illustrated with respect to pull down menu 36, a service level request may be incorporated in the message indicating the duration of the prescription history required by the insurer. A first level may indicate a request for up to six months of prescription history, a second level may indicate a request for up to twelve months of history and a third level may indicate a lifelong prescription history. Alternatively, instead of providing the insurer with a variety of service level options, the system may simply obtain all of the prescription history information for each applicant or insured.

Additionally, as shown on FIG. 3, the user may input a request for additional information. In a preferred embodiment, the user has at least three options for requesting information in addition to a list of drugs prescribed to the applicant or insured over the time period of the service level requested. Specifically, options A, B and C are available. In option A, the insurer requests that the names of the prescribing physicians be transmitted along with the prescription history. The insurer may request this option by selecting box 37 in FIG. 3. In option B, the insurer requests an abbreviated response, or turnaround time, from the system. The insurer may request this option by selecting box 38 in FIG. 3. In option C, the insurer requests information regarding the drug categories and drug indications associated with the drugs in the prescription history. Drug indications include the type of conditions, diseases or ailments associated with the prescription in the prescription history. Drug categories include the type of drug that was prescribed. The insurer may request this option by selecting box 39 in FIG. 3. Alternatively, one or more of these options may be packaged as part of every request. For instance, options A and C may be provided for each request.

The history request message may also include proof of the authorization signed by the applicant or insured. The authorization may be provided in any of a number of formats. For instance, digital document including the signature of the applicant or insured may be transmitted as a file attached to the other components of the history request message. Alternatively, the applicant or insured may place a digital signature on the history request message.

Alternatively, rather than manually generating a history request such as through the user interface of FIG. 3, a history request may be automatically generated. In one example, rules specific to each insurer could automatically initiate a history request. For instance, a request for prescription history may be automatically generated for each policy over a threshold value. In another example, the generation of a history request could be initiated when a specific test was ordered. In another alternative, the history request may be generated in response to a specific test result rather than upon the receipt of a test order. For instance, medical tests are oftentimes performed to determine if certain enzymes are present in an individual's liver. While merely ordering of the test may not be indicative of a medical problem, a specific test result may indicate a condition relevant to the insurability of the individual. In this alternative, upon input of a certain test result or test results, the system may automatically generate a history request. Additionally, more than one factor may be considered by the system prior to initiating an automatic order. For instance, certain medical test results may initiate an automated order for individuals of a certain age. These type of rules may be executed at the central server.

In the preferred embodiment, once the relevant information and options have been selected, the insurer submits the request by clicking on box 40. The history request message may be encrypted prior to being transmitted over the network. Once the history request message is received, the message is unencrypted and recorded at step 42. Preferably, the request message is recorded in the database clusters 24 associated with the control server 22. Next, at step 44, a confirmation message is sent to the insurer via the network 26. The message confirms the time and date that the message was received, and also indicates the service level and options selected by the requesting insurer.

Next, at step 46, a control number is assigned to each request message that is received from the insurer's remote computer. Once the control number is assigned, at step 48, the system transmits a series of individual requests to the PBM remote computers 28. The individual requests are preferably encrypted prior to being transmitted over the network. Each request includes information similar to the history request messages sent at step 30. The requests are then received, unencrypted and processed at the PBM computers using existing rules for searching eligibility and claims systems stored within the PBM databases.

Once the processing is complete, the server 22 receives the individual responses from the PBM remote computers at step 50. Again, each of the individual responses sent from the PBM remote computers is preferably encrypted prior to transmission over the network, and unencrypted upon receipt at the central server. Next, at step 52, the system matches each of the individual response messages to the corresponding history request message. For instance, each of the individual response messages may include an identifier indicating the control number of the history request message, and the responses grouped according to the number. At step 54, each individual response is read and stored with the database cluster 24. Each individual response message includes a number of items of information detailing the results of the query. Specifically, each message indicates whether the individual was found in the query, whether a prescription history associated with him or her was present, the prescription history information (such as prescribing physician and drug information) and a flag, which indicates whether Options A and C were completed (if requested).

Preferably, each individual response message received from a PBM remote computer has one of three outcomes: HIT, NOHIT and CLEAR. A HIT outcome indicates that the individual was found with a prescription history. A NOHIT outcome indicates that the individual was not found in the PBM database. A CLEAR outcome indicates that the applicant or insured was found in the PBM database without a prescription history. In some cases, a fourth outcome indicating a status of ERROR is returned. For example, if option B is requested as part of the history request message, only those messages returned within the abbreviated time frame are aggregated at step 56. Likewise, an acceptable time frame is set for the requests not submitted under Option B. The system monitors the turnaround time from when the individual requests were transmitted at step 48 to the time that the individual response messages were received from the PBM remote computers at step 50. If an individual response message is not received at step 50 within the abbreviated or default time period, an outcome of ERROR is returned.

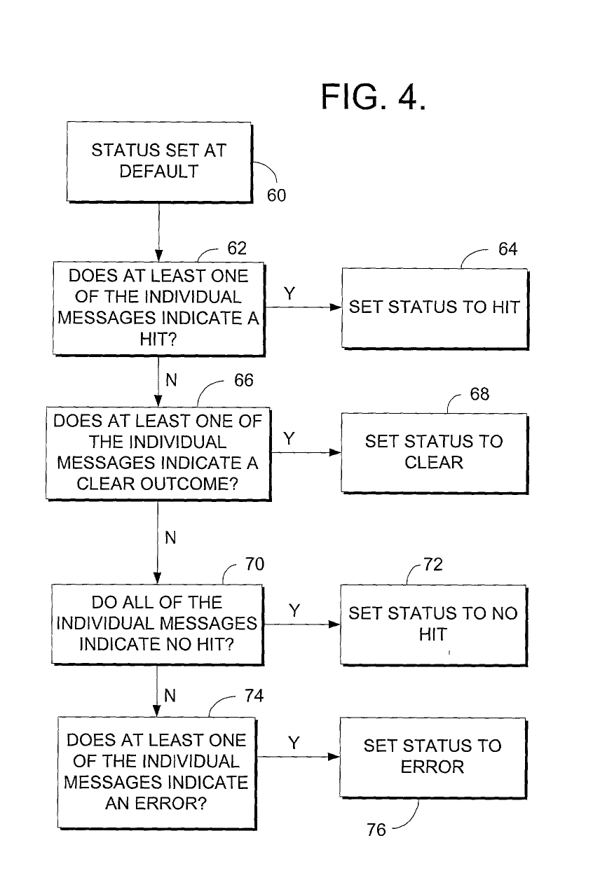

At step 56, the system generates an aggregate history response message from the individual response messages received at step 50. Turning to FIG. 4, at the outset of the aggregation process, the status of the aggregate history response message is set to a default at step 60. At step 62, the system determines if any of the individual messages indicates a HIT outcome. If a HIT outcome is returned in any of the messages, the status is set to HIT at step 64. If none of the outcomes returns a HIT, the system determines if at least one of the individual messages indicates a CLEAR outcome at step 66. If a CLEAR outcome is present in any of the individual messages, the status of the aggregate history response message is set to CLEAR at step 68. If none of the outcomes is CLEAR, then the system determines if all of the individual messages indicate NOHIT at step 70. If all of the individual message indicate NOHIT, then the status of the aggregate history response message is set to NOHIT at step 72. If all of the individual messages do not have an outcome of NOHIT, the system determines if at least one of the individual messages indicates an ERROR outcome at step 76, and sets the aggregate status to ERROR in step 76 if an ERROR outcome is returned.

In addition to the primary outcome information, if a HIT outcome is sent, the individual response messages also include the prescription history in accordance with the service level requested. The prescription history includes the prescribing physician [symbol] s name, if available, in addition to the list of prescriptions prescribed over the relevant period of the individual [symbol] s life. The list of prescription information may include the drug name, form, strength, days supplied, and date dispensed. Contact information for the prescribing physicians may also be provided to facilitate further investigation by the insurer. Other information typically received includes the date upon which the individual started coverage, the PBM name, and any reported medical conditions. As part of the aggregation process, the system determines the drug category information and drug indication information for each drug that has been prescribed to the applicant or insured. Preferably, the system accesses a database relating the drug category and indications to each possible drug. The database may be maintained within the database cluster 24, or may be accessed on a remote server of a third party that updates and maintains drug information. The remote server may be accessed through the network 26 as within the knowledge of those of ordinary skill.

In addition to accessing and incorporating drug indication information for each drug prescribed to the individual, the system may perform further processing of the information provided by the PBM databases. For instance, the system may determine the probability that the prescription indicates a particular condition. Thus, in addition to providing the possible indications, the system would provide the insurer with the likelihood that the applicant or insured has each of the conditions indicated by the prescribed drug. Additionally, expert rule systems may be incorporated within the system for providing mortality information based on the prescription drug history information.

In aggregating the history response message, the system excludes the prescription drug information for the prescriptions detailed in the individual response messages that were dispensed outside the time period of service requested. In addition to the prescription history information, the response message may include additional comments regarding the results. For instance, if a PBM remote computer does not provide a response message within the proper timeframe, the system attaches text indicating that the information is not available. Namely, if Option B is identified in the history request message, the system sends a message that the “PBM database not available during express timeframe.” Likewise, if Option B is not selected, but no response is received within the default timeframe, the message preferably indicates that the “PBM database not available during non-express timeframe.” In another example, if the PBM returns an incomplete prescription history, the system will incorporate text to alert the insurer that the report is incomplete.

Ultimately, at step 78, the aggregate response message is transmitted. The response is preferably sent to a remote computer of the insurer via the network 26. For instance, the message may be accessible by the insurer on a website associated with the system. Various other delivery techniques such as facsimile transmission, delivery to a wireless device, or traditional mail may be used to deliver the results. Typically, the message may be formatted as a report incorporating the relevant information described above.

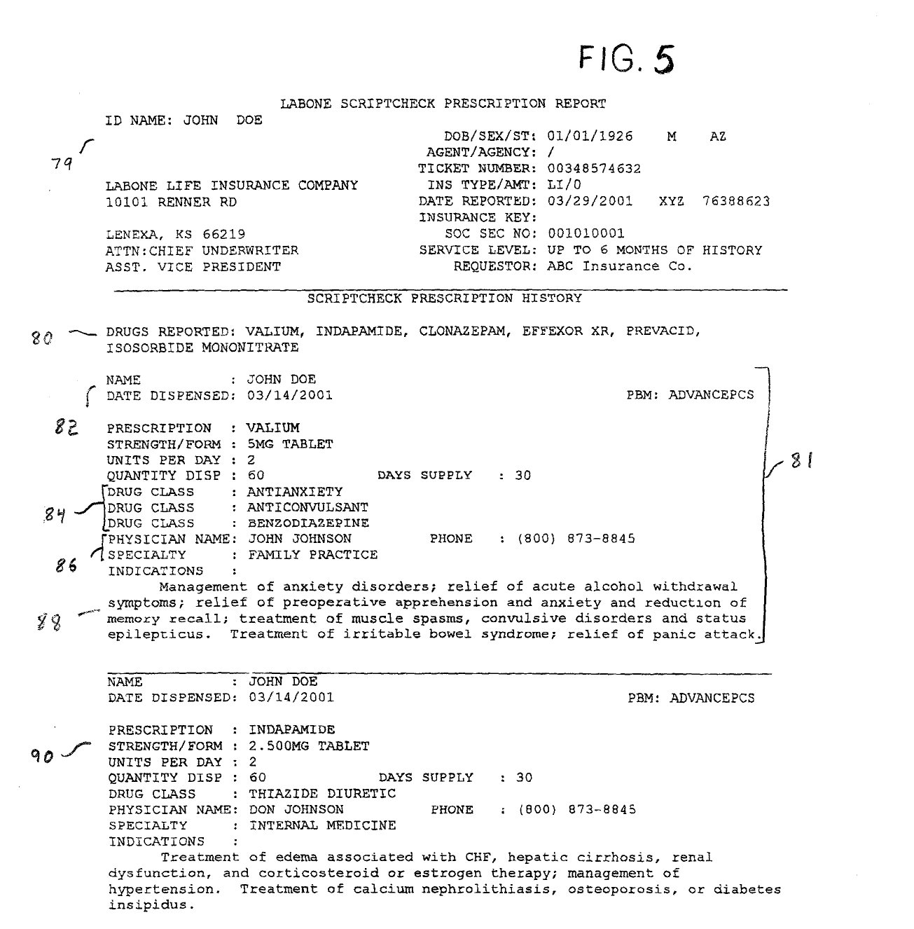

With reference to FIG. 5, an exemplary report generated by the information of the aggregate response message is shown. The report is typical of an aggregate response where at least one HIT was found at a PBM database. At header 79, the information of the requester, applicant or insured, and the service level requested are summarized. The date of the report is also displayed. Below the general information, a summary of all of the unique drugs reported in the prescription history is displayed at 80. Below the summary, a comprehensive record of each of the drugs prescribed is displayed. The first drug record 81 includes the name and date of each drug dispensed at lines 82, the name of the drug class or category at lines 84 and the prescribing physician information at 86. Finally, at 88, the indications for the particular drug are summarized to give the insurer an understanding of the likely ailment, disease or other condition being treated by the drug. A second drug record 90 is displayed below the first drug record 81. Each drug listed at 80 has a drug record for consideration by the insurer.

The prescription history information provides the insurer with instantaneous information for making an informed decision about the insurance related risks. Specifically, the computer system or insurer may accept, reject or affect the individual's insurance rating depending on the information in the individual's prescription history. As understood by those of ordinary skill, actuarial tables and formulas are typically used to determine which of the insurance actions are taken. The information may be used alone to make the determination, or may be used to determine if additional investigation is needed. However, it is preferred that additional investigation be required. For instance, the names of the prescribing physicians may be used as a basis for an extensive medical background check.

While the invention is described with reference to a method in a computer system, one or more of the steps may be performed outside the computer system. For example, the prescription history information could be conveyed to the insurer via conventional means such as regular mail, verbal communication and the like. Specifically, the report may be generated and printed at a site associated with the server and subsequently communicated to the insurer without using the computer network. In another alternative, individual history requests may be generated and sent from a computer associated with the insurer. In this embodiment, the PBM responses are returned to and aggregated by the requesting computer.

Although the invention has been described with reference to the preferred embodiment illustrated in the attached drawing figures, it is noted that substitutions may be made and equivalents employed herein without departing form the scope of the invention as recited in the claims. For example, additional steps may be added and steps omitted without departing from the scope of the invention.

1. A method in a computer system for providing prescription drug history information of an individual to an insurer, comprising the steps of:
receiving a history request message;
transmitting a plurality of individual history requests over a communication network to a plurality of client machines of pharmacy benefit managers, and receiving at least one prescription history response generated by accessing a database of stored prescription history information at one of said client machines.

2. The method as recited in claim 1, further comprising transmitting prescription history information to the insurer.

3. The method as recited in claim 1, wherein a plurality of prescription history responses are received.

4. The method as recited in claim 3, further comprising the step of aggregating said plurality of prescription history responses.

5. The method as recited in claim 1, wherein each said prescription history response includes a list of drugs prescribed to the individual.

6. The method as recited in claim 2, wherein each said prescription history response includes a list of drugs prescribed to the individual, and wherein the prescription history information transmitted to the insurer includes said list of drugs.

7. The method as recited in claim 6, wherein the history request message includes a request for a specific duration of prescription history and wherein said prescription history information transmitted includes prescription history information for said specific duration.

8. The method as recited in claim 5, wherein the prescription history information transmitted to the insurer includes drug indication information for each of said drugs of said list.

9. The method as recited in claim 5, wherein the prescription history information transmitted to the insurer includes drug category information.

10. The method as recited in claim 2, wherein said history request includes a request for drug indication information.

11. The method as recited in claim 2, wherein each said history request includes a request for prescribing physician information.

12. The method as recited in claim 2, further comprising the step of determining an insurance action based on said prescription history information.

13. The method as recited in claim 12, wherein said determined insurance action is accepting an application.

14. The method as recited in claim 12, wherein said determined insurance action is obtaining further information.

15. The method as recited in claim 12, wherein said insurance action is selecting an insurance rating.

16. A computer system for providing prescription drug history information of an individual to an insurer, the computer system comprising:
a receiving component that receives a history request message;
a transmitting component that transmits a plurality of individual history requests over a communication network to a plurality of client machines of pharmacy benefit managers, and
a receiving component that receives at least one prescription history response generated by accessing a database of stored prescription history information at one of said client machines.

17. The system as recited in claim 16, further comprising a second transmitting component that transmits prescription history information to the insurer.

18. The system as recited in claim 17, wherein said receiving component receives a plurality of prescription history responses.

19. The system as recited in claim 18, further comprising an aggregating component that aggregates said plurality of prescription history responses.

20. The system as recited in claim 16, wherein each said prescription history response includes a list of drugs prescribed to the individual.

21. The system as recited in claim 16, wherein each said prescription history response includes drug category information.

22. The system as recited in claim 17, wherein each said prescription history response includes a list of drugs prescribed to the individual, and wherein the prescription history information transmitted to the insurer includes said list of drugs

23. The system as recited in claim 17, wherein said history request includes a request for drug indication information.

24. The system as recited in claim 17, wherein said history request includes a request for prescribing physician information.

25. A system as recited in claim 17, further comprising a determining component for determining an insurance action based on said prescription history information.

26. A system as recited in claim 17, wherein said insurance action is determined from a group consisting of accepting an application, obtaining further information, rejecting an application and selecting an insurance rating.

27. A computer-readable medium containing instructions for controlling a computer system to provide prescription history information of an individual to an insurer, by:
receiving a history request message;
transmitting a plurality of individual history requests over a communication network to a plurality of client machines of pharmacy benefit managers, and
receiving at least one prescription history response generated by accessing a database of stored prescription history information at one of said client machines.

28. The computer readable medium as recited in claim 27, further comprising transmitting prescription history information to the insurer.

29. The computer readable medium as recited in claim 27, wherein a plurality of prescription history responses are received.

30. The computer readable medium as recited in claim 29, further comprising the step of aggregating said plurality of prescription history responses.

31. The computer readable medium as recited in claim 27, wherein each said prescription history response includes a list of drugs prescribed to the individual.

32. The computer readable medium as recited in claim 27, wherein each said prescription history response includes a list of drugs prescribed to the individual, and wherein the prescription history information transmitted to the insurer includes said list of drugs.

33. The computer readable medium as recited in claim 32, wherein the history request message includes a request for a specific duration of prescription history and wherein said prescription history information transmitted includes prescription history information for said duration.

34. The computer readable medium as recited in claim 31, wherein the prescription history information transmitted to the insurer includes drug indication information for each of said drugs of said list.

35. The computer readable medium as recited in claim 28, wherein said history request includes a request for drug indication information.

36. The computer readable medium as recited in claim 28, wherein said history request includes a request for drug category information.

37. The computer readable medium as recited in claim 27, wherein each said history request includes a request for prescribing physician information.

38. A method for screening the prescription history of an individual, the method comprising the steps of:
receiving a history request from an insurer, said history request including an identification of an individual;
sending a plurality of individual requests for prescription history information to a plurality of pharmacy benefit managers, and
receiving prescription history information from at least one of said prescription benefit managers.

39. The method as recited in claim 38, further comprising transmitting the prescription history information of said individual to said insurer.

40. The method as recited in claim 39, further comprising determining an insurance action based on said prescription information transmitted to said insurer.

41. A method as recited in claim 39, wherein said insurance action is determined from a group consisting of accepting an application, rejecting an application and selecting an insurance rating.

42. A method for screening the prescription history of an individual comprising the steps of:
sending a plurality of requests for prescription history information to a plurality of pharmacy benefit managers, and
receiving prescription history responses from at least one of said prescription benefit managers.

43. The method as recited in claim 42, wherein a plurality of prescription history responses are received from said prescription benefit managers.

44. The method as recited in claim 42, wherein the step of sending is automatically initiated when a laboratory test of a specific type is ordered.

45. The method as recited in claim 42, wherein the step of sending is automatically initiated when a specific laboratory test result for the individual is present.

46. The method of claim 42, further comprising the step of determining an insurance action.

47. The method of claim 46, wherein the insurance action is determined from a group consisting of accepting an application, rejecting an application and selecting an insurance rating for the individual.

48. A method in a computer system for screening the prescription history of an individual, comprising the steps of:
sending a plurality of requests for prescription history information to a plurality of pharmacy benefit managers, and
receiving prescription history responses from at least one of said prescription benefit managers.

49. The method as recited in claim 48, wherein a plurality of prescription history responses are received from said prescription benefit managers.

50. The method as recited in claim 48, wherein the step of sending is automatically initiated when a laboratory test of a specific type is ordered.

51. The method as recited in claim 48, wherein the step of sending is automatically initiated when a specific laboratory test result for the individual is present.

52. The method of claim 48, further comprising the step of determining an insurance action.

53. The method of claim 52, wherein the insurance action is determined from a group consisting of accepting an application, obtaining further information, rejecting an application and selecting an insurance rating for the individual.

54. A method for providing prescription history information of an individual, the method comprising the steps of:
receiving a history request identifying the individual at a plurality of prescription benefit managers, each prescription benefit manager having a database;
generating a prescription history response by searching said databases, and
aggregating said responses to provide a prescription history for the individual.
